(19) United States
(12) Patent Application Publication
(10) Pub. No.: US 2026/0217407 A1
(43) Pub. Date: Jul. 30, 2026

(54) CONTAINER HAVING AN IMPROVED PETALOID BOTTOM, AND MOULD BOTTOM FOR PRODUCING SUCH A CONTAINER

(71) Applicant: SIDEL PARTICIPATIONS, Octeville-sur-Mer (FR)

(72) Inventors: Laurent NAVEAU, OCTEVILLE-SUR-MER (FR); Michel BOUKOBZA, OCTEVILLE-SUR-MER (FR)

(21) Appl. No.: 19/144,379

(22) PCT Filed: Dec. 27, 2023
(86) PCT No.: PCT/EP2023/087820

§ 371 Date: Jun. 27, 2025

(30) Foreign Application Priority Data
Dec. 30, 2022 (FR) FR2214711

(51) Int. Cl. B65D 1/02; B29C 49/48

(52) U.S. Cl. CPC B65D 1/0284; B29C 49/48; B29C 2049/4892

(57) ABSTRACT

Provided is a plastic container obtained by blow moulding or stretch blow moulding. The container has a body wall, a shoulder in the upper end of the body, a neck in the extension of the shoulder, and a petaloid bottom. The bottom has an outwardly convex wall, from which feet extend from a central region of the bottom. The tops of the feet are coplanar and jointly form a circular base via which the container can rest on a flat surface. Each foot has an end face extending in a gentle slope from the central region of the bottom towards the bottom of the foot. The end face of has a central section extending in the direction of the top of the foot with an outwardly facing concavity, and a peripheral section extending to the bottom of the foot with an outwardly facing convexity.

### TECHNICAL FIELD

The present invention relates to the production of containers, in particular bottles, obtained by blow molding or stretch blow molding, from blanks, also commonly called preforms or intermediate containers, made of plastic material such as polyethylene terephthalate (PET) and/or recycled polyethylene terephthalate (rPET). More particularly, the present invention relates to a container having a petaloid bottom and a mold bottom for producing such a container, enabling an improved distribution of the material during the blow molding of the bottom and ultimately an improved mechanical strength of the bottom of said container.

### STATE OF THE ART

In the field of producing containers made of PET, it is well known that a container generally comprises an open neck via which the contents (generally a liquid) is introduced, a body which provides the container with its volume, and a bottom which closes the body opposite the neck and forms a base designed to ensure the strength and the hold of the container when it rests on a surface.

The containers which are designed for carbonated beverages, in which the pressure of the gas dissolved in the liquid causes significant mechanical stresses, are mostly provided with bottoms of petaloid shape: the bottom comprises protruding feet in the shape of petals, separated by convex wall portions, called troughs or valleys, which extend radially from a central region of the bottom. The feet are designed to ensure the hold of the container placed on a surface; the valleys are designed to absorb the (thermal, mechanical) forces exerted by the container.

The performance of a petaloid bottom is measured in terms of its mechanical strength—i.e. its capacity to be deformed in a limited or controlled manner—not only during filling but also during the storage of the container. The storage can be prolonged and carried out under extreme conditions of temperature and humidity which are exceptionally encountered in temperate countries but regularly encountered in countries having a continental, tropical or desert climate.

It is desirable to avoid a frequent deformation, which is the sagging of the central region of the bottom, since this results in sensitivity to “stress”, a change in the configuration of the feet and ultimately a lack of stability of the container. It should also be noted that the producers of containers also wish to satisfy the requests of retailers, without resulting in a reduction in the production rate of said containers, or conversely if possible with higher production rates.

In this regard, an improved technical solution has already been proposed, this solution over time improving the stability of the bottoms of the containers, which are filled under pressure and which are stored in a hot and humid atmosphere, without affecting the production rate. This is the case, in particular, in the document FR 2897292.

The document FR 2897292 describes a mold bottom for a mold for producing, by blow molding or stretch blow molding, containers, in particular bottles, made of thermoplastic material such as PET, said containers having a body and having a bottom of the so-called petaloid type with a plurality of feet which are angularly distributed equidistantly, which extend approximately parallel to the axis of the container and which are separated from one another by radiating valleys having a bottom of convex extent, said mold bottom having a mold cavity comprising, for the molding of said bottom of the containers, a plurality of cavities which are angularly distributed equidistantly, which extend approximately parallel to the axis of the mold bottom and which are separated from one another by radiating ridges having a crest of concave extent, the bottoms of said cavities being distributed over a substantially circular contour. Said mold bottom is characterized by the fact that each cavity, considered radially on either side of its lowest point, is defined: outwardly by a curved surface portion which in radial section is substantially circular arc-shaped, and inwardly by a surface portion in a broken plane with at least two slopes which intersect said curved surface portion along a straight ridge extending substantially circumferentially, the plane containing said straight ridge, which is tangent to said curved surface portion, being substantially perpendicular to the axis of the mold cavity and the plane portion adjacent to the curved surface portion having a slope of between approximately 12° and 8° relative to said tangent plane.

Due to this arrangement, the two curved surface portions in a broken plane are connected by a ridge creating, for each foot of the container bottom, a stiffened bearing line of approximately circumferential extent, via which each foot rests on a flat support. This ridge remains the bearing contact of the foot on a flat support whatever the deformation and/or inclination undergone by the foot under the effect of the sagging of the central part of the container bottom.

Although this type of mold bottom improves the stability of the bottoms of the stored containers over time, it does not entirely satisfy the constraints of mechanical performance which is ideally high, of weight which is ideally low, and of blowability which is ideally simple.

In order to remedy these drawbacks, the document FR 2967975 describes a container made of plastic material comprising a body and a petaloid bottom extending the body, the bottom comprising a bottom wall of generally outwardly convex shape, feet formed by protrusions protruding therefrom, the feet being separated in pairs by portions of the bottom wall forming hollow valleys which extend radially from a central region of the bottom to a periphery of the bottom, a container in which each valley enlarges from the central region to the periphery and has a concave portion located in the vicinity of the periphery.

Such a container has the advantage of having greater resistance to deformation. Particularly noteworthy is a good maintenance of the central region of the bottom under hydrostatic pressure, possibly combined with the pressure of the dissolved gas in the case of a carbonated beverage. These performances are observed not only during filling but also during prolonged storage under severe conditions of humidity and pressure.

However, none of these mold bottoms and/or containers of the prior art enable a sufficient mechanical strength of the containers to be obtained when rPET is used for the production thereof. More specifically, the use of rPET complicates the distribution of the material during the stretch blow molding and/or blow molding of the container. More specifically, in this case, it is more difficult to break up the amorphous material located in the center of the bottom of the bottle, which generates an increased risk of developing stress between the amorphous region and the bi-oriented region. “Stress” is understood to mean stress marks in the material such as cracks or fissures, for example, which weaken the bottom of the container.

### DISCLOSURE OF THE INVENTION

One of the objects of the invention is thus to remedy these drawbacks by proposing a container and a mold bottom for the production of such a container of simple and inexpensive design, which achieves a good mechanical strength of the bottom of the containers while permitting higher production rates.

To this end, and according to the invention, the invention proposes a container obtained by blow molding or by stretch blow molding from a blank made of plastic material, which comprises a body consisting of a substantially cylindrical wall, a shoulder in the extension f said body at an upper end thereof, a neck in the extension of the shoulder, and a bottom of the petaloid type at the lower end of said body, said bottom comprising a wall of generally outwardly convex shape, from which at least three feet formed by protrusions protruding towards the outside of the container extend, these feet extending from a pellet-shaped central region of the bottom, where the material has remained substantially amorphous, towards a periphery of the bottom where the latter connects to the body, the most protruding parts or tops of the feet are coplanar and jointly form a base via which the container can rest on a flat surface, said base being circular and having a so-called base diameter, and each foot having an end face which extends in a gentle slope from the central region of the bottom towards the bottom of said foot; said container is noteworthy in that said end face of each foot comprises at least two sections, a first so-called central section extending from the central region of the bottom in the direction of the top of the foot and having an outwardly facing concavity, and a second so-called peripheral section extending from the central section to the bottom of the foot and having an outwardly facing convexity.

Such a construction of the foot, and more particularly such a specific construction in the shape of a curve connecting the feet towards the center, advantageously enables the material to be displaced more easily towards the base and thus a more gradual transition of the material to be obtained from the center towards the base region during the stretch blow molding production step.

Preferably, the radius of curvature of the second peripheral section is between 0.5 and 3 times the base diameter.

Moreover, the radius of curvature of the central section is preferably between 0.3 and 0.6 times the base diameter.

Moreover, the radius of curvature of the peripheral section and/or the radius of curvature of the central section is not constant.

In addition, the clearance 4 the bottom corresponding to the height between the central region of the bottom and the tops of the feet, i.e. the base plane, is between 0.05 and 0.15 times the base diameter.

Advantageously, each foot has two substantially flat sides which each laterally border a valley, said sides of the feet being connected to the valley via concave fillets, the radius of curvature thereof not being constant from the central region to the connecting region of each valley.

Such a construction of the foot, and more particularly such a specific construction of the concave fillets connecting the sides of two adjacent feet to a valley, advantageously enables the material to be displaced more easily towards the base and thus a more gradual transition of the material to be obtained in the region of the valley from the center to the base region during the stretch blow molding production step.

Preferably, said radius of curvature of the concave fillets is variable over a length L₁ of the valley from the central region and is substantially constant from said length Li to the connecting region.

Said length L₁ is between 0.2 and 0.8 times the base diameter pa and is preferably equal to 0.5 times said base diameter φa.

Furthermore, over a part L₂ of the length L₁, said concave fillets are separated by a space E which is less than or equal to 2 mm, the starting point of the length L₂ being the central region. Said space E can be zero.

Said length L₂ from the central region is between 0.1 and 0.4 times the base diameter a and is preferably equal to 0.3 times said base diameter φa.

Furthermore, over a remaining length L₃ of the length L₁, the so-called transition length, the radius of curvature of the concave fillets gradually reduces until it reaches the value of the substantially constant radius of curvature of the concave fillets defined for the region extending between the end of the length Li to the connecting region.

A further subject of the invention relates to a mold bottom for a mold for producing, by blow molding or stretch blow molding, containers, in particular bottles, made of thermoplastic material such as PET, said containers comprising a body consisting of a substantially cylindrical wall, a shoulder in the extension of said body at an upper end thereof, a neck in the extension of the shoulder, and a bottom of the petaloid type at the lower end of said body, said bottom comprising a wall of generally outwardly convex shape, from which extend at least three feet formed by protrusions which are angularly distributed equidistantly, which extend approximately parallel to the axis of the container and which are separated from one another by radiating valleys having a bottom of convex curvilinear radial extent, said mold bottom comprising, for the molding of said bottom of the containers, at least three cavities which are angularly distributed equidistantly, which extend substantially parallel to the axis of the mold bottom and which are separated from one another by radiating ridges having a crest of concave radial extent, the bottoms of said cavities being distributed over a substantially circular contour corresponding to the so-called base diameter pa of the container, and each cavity having a bottom face which extends in a gentle slope from the central region of the bottom towards the bottom of the cavity; said mold bottom being noteworthy in that said bottom face of each cavity comprises at least two sections, a first so-called central section extending from the central region of the mold bottom in the direction of the bottom of the cavity and having an inwardly facing convexity of the mold bottom, and a second so-called peripheral section extending from the central section to the bottom of the cavity and having an inwardly facing concavity of the mold bottom.

Preferably, the radius of curvature of the second peripheral section is between 0.5 and 3 times the base diameter φa.

Moreover, the radius of curvature of the central section is preferably between 0.3 and 0.6 times the base diameter φa.

Moreover, the radius of curvature of the peripheral section and/or the radius of curvature of the central section is not constant.

In addition, the clearance of the bottom corresponding to the height between the central region of the mold bottom and the bottom of the cavities is between 0.05 and 0.15 times the base diameter φa.

Advantageously, said mold bottom comprises, on either side of the crest, a convex fillet connecting the ridges extending on either side of the crest, the radius of curvature of said convex fillet not being constant from the central region towards the edge of the central indentation.

Preferably, said radius of curvature of the convex fillets is variable over a length L₁ of the crest from the central region and is substantially constant from said length L₁ to the edge of the central indentation.

Said length L₁ is between 0.2 and 0.8 times the base diameter pa and is preferably equal to 0.5 times said base diameter pa.

Furthermore, over a part L₂ of said length L₁, said length L₂ corresponding to a length of which the starting point is the central region, the convex fillets are separated by a space E which is less than or equal to 2 mm. Said space E can be zero.

Said length L₂ from the central region is between 0.1 and 0.4 times the base diameter φa and is preferably equal to 0.3 times said base diameter φa.

Furthermore, over a remaining length L₃ of the length L₁, the so-called transition length, the radius of curvature of the convex fillets gradually reduces until it reaches the value of the substantially constant radius of curvature of the convex fillets defined for the region extending between the end of the length L₁ to the edge of the central indentation.

A final subject of the invention relates to a molding device for producing, by blow molding or stretch blow molding, containers, in particular bottles, from preforms made of thermoplastic material such as PET, said containers comprising a body consisting of a substantially cylindrical wall, a shoulder in the extension of said body at an upper end thereof, a neck in the extension of the shoulder, and a bottom of the petaloid type at the lower end of said body, said bottom comprising a wall of generally outwardly convex shape, from which extend at least three feet formed by protrusions which are angularly distributed equidistantly, which extend approximately parallel to the axis of the container and which are separated from one another by radiating valleys having a bottom of convex curvilinear radial extent, said molding device comprising at least one mold bottom which is capable of being movably mounted in a lateral wall which defines a cavity with the impression of a part of the container, said lateral wall comprising two half-molds each defining a half-impression of the body of the container and rotatably mounted relative to one another between a so-called open position in which the half-molds are angularly separated from one another and the mold bottom is lowered relative to the half-molds in order to permit the introduction of the preform and the removal of the molded container, and a so-called closed position in which the half-molds are applied against one another and capture between one another the mold bottom, thus to form the cavity and to define the total footprint of the container to be molded, said mold bottom comprising at least three cavities which are angularly distributed equidistantly, which extend substantially parallel to the axis of the mold bottom and which are separated from one another by radiating ridges having a crest of concave radial extent, the bottoms of said cavities being distributed over a substantially circular contour; said device being noteworthy in that the mold bottom is arranged according to the above-described invention.

### BRIEF DESCRIPTION OF THE DRAWINGS

Further advantages and features will become more apparent from the following description of a single variant, provided by way of non-limiting example, according to the invention with reference to the accompanying drawings, in which:

FIG. 1 is a partial perspective view from below of a container having a petaloid bottom according to the invention,

FIG. 2 is a side view of the lower part of the container having a petaloid bottom according to the invention shown in FIG. 1,

FIG. 3 is a view from below of the bottom of the container according to the invention shown in FIGS. 1 and 2,

FIG. 4 is a sectional view of the bottom of FIG. 3, along the cutting plane IV-IV′,

FIG. 5 is a view of the cross section of the sectional view shown in FIG. 4,

FIG. 6 is a partial perspective view from below of a variant of the bottom of a container having a petaloid bottom according to the invention,

FIG. 7 is a side view of the lower part of the variant of the container having a petaloid bottom according to the invention shown in FIG. 6,

FIG. 8 is a view from below of the bottom of the variant of the container according to the invention shown in FIGS. 6 and 7,

FIG. 9 is a schematic sectional view of two adjacent feet of the bottom of the variant of the container according to the invention shown in FIGS. 6 and 7,

FIG. 10 is a perspective view of a mold bottom according to the invention,

FIG. 11 is a view from above of the mold bottom according to the invention shown in FIG. 10,

FIG. 12 is a sectional view of the mold bottom of FIG. 11 along the cutting plane XII-XII'.

### EMBODIMENT OF THE INVENTION

In the remainder of the description of the container according to the invention, the same reference numerals denote the same elements. The different views are not necessarily drawn to scale.

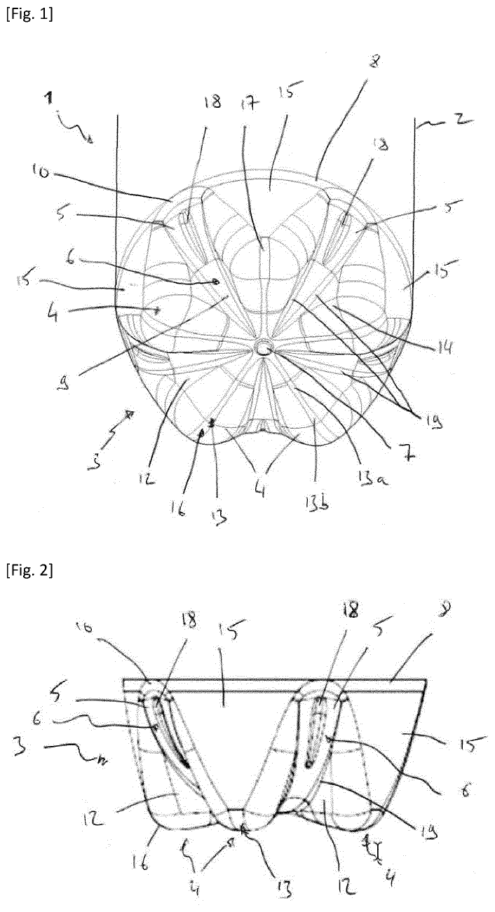

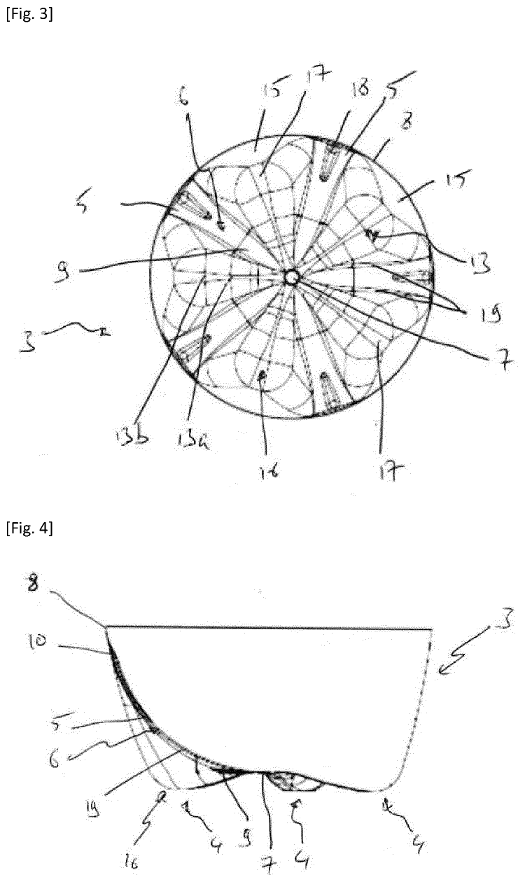

With reference to FIGS. 1 to 3, the container 1 according to the invention is a bottle which is designed, for example, to contain a gaseous or carbonated beverage. The bottle is produced from PET and/or from rPET by extrusion blow molding or injection blow molding the constituent material thereof. The invention preferably applies to this type of container. However, it is obvious that said container 1 could be produced from any other thermoplastic material known per se or from a mixture of various materials without departing from the scope of the invention.

Said container 1 comprises in the usual manner a body 2 forming a cylindrical wall and extending from a petaloid type bottom 3, surmounted by a shoulder, leading to a neck, terminated by a neck opening which is threaded or adapted in any other manner to receive a cap, the shoulder, the neck, the neck opening and the cap not being shown in FIG. 1.

Said petaloid bottom 3 comprises feet 4 formed by protrusions extending from a substantially hemispherical wall 5 with an outwardly facing convexity and forming valleys 6 between two adjacent feet 4, the hemispherical wall 5 forming the bottom of said valleys 6. The upper end of each foot 4 leads to the body 2.

In this particular exemplary embodiment, said petaloid bottom 3 has five protrusions forming the feet 4 which are angularly distributed equidistantly, which extend approximately parallel to the longitudinal axis of the container 1 and which are separated from one another by radiating valleys 6 having a bottom of convex curvilinear radial extent. All of the valleys 6 converge towards a so-called central region 7 of the bottom 3, said central region 7 consisting of a slightly outwardly protruding circular plate or pellet where the material remains substantially amorphous. The bottom 3 of the container 1 is connected to the body 2 of the container 1 by a so-called connecting region 8 which is substantially cylindrical in revolution.

Thus the feet 4 are separated in pairs by portions of the bottom wall 5 called valleys 6, which extend radially in a star shape from the central region formed by the central region 7 to the periphery formed by the connecting region 8. The valleys 6 are outwardly concave in cross section, i.e. in a plane perpendicular to the radial direction. The radius of curvature of the valleys 6 can be variable. More specifically, it is preferably small in the vicinity of the central region 7 and relatively larger in the vicinity of the connecting region 8.

Moreover the valleys 6 have, in the vicinity of the central region 7, an outwardly convex internal section 9 in radial section and, in the vicinity of the connecting region 8, an outwardly concave external section 10 in radial section.

In the example illustrated in the drawings, the bottom 3 comprises five feet 4 and five valleys 6 regularly alternating and distributed in a star shape. This number constitutes a good compromise; but it could be less (but greater than or equal to three) or more (but preferably less than or equal to seven). Moreover, the most protruding parts or tops 16 of the feet 4 are coplanar and jointly form a base via which the container 1 can rest on a flat surface, said base being circular and having a so-called base diameter which is denoted pa in the remainder of the description and each foot 4 has an end face 13 which extends in a gentle slope from the central region 7 of the bottom 3 towards the bottom of said foot 4.

Each foot 4 has two substantially flat sides 12 which each laterally border a valley 6. Said sides 12 are not vertical (since the base 3 would then be difficult, or even impossible, to blow mold) but inclined, opening from the valley 6 to the outside. Said sides 12 are connected to the end face 13 by a fillet 14. Each foot 4 is also radially delimited by an external face 15 which extends in the extension of the body 2 to the vicinity of the top 16 of the foot 4, to which the external face 15 is connected by a fillet 17. The external face 15 is not cylindrical but substantially conical in revolution about the longitudinal axis of the container 1. Moreover, in radial section this face 15 is not straight but convex with a large radius of curvature. On the periphery of the bottom 3, the face 15 is connected to the body 2 via the connecting region 8 which is in the form of a fillet.

Advantageously, the bottom 3 is also provided with radial grooves 18 which extend in a hollow manner to the inside of the container 1, along the valleys 6.

More specifically, each radial groove 18 extends along a median line of a valley 6 from the vicinity of the central region 7 to the vicinity of the connecting region 8. Each groove 18 has in plan view a substantially oblong shape, the edges thereof being parallel over the majority of the length and the ends thereof being both flared. In radial section, each groove 18 has a flared U-shaped profile. Said grooves 18 have the function of stiffening the bottom 3. Under the effect of the mechanical stresses exerted on the container 1 (in particular under the effect of the pressure prevailing in the container filled with a carbonated liquid) the grooves 18 tend to creep by expanding and flattening which causes an enlargement of the valleys 6 and, as a result, a verticalization of the feet 4 which opposes the general sagging of the bottom 3.

Moreover, each valley 6 is enlarged from the central region 7 to the connecting region 8. This enlargement is preferably continuous, i.e. the edges of the valleys 6 form an angle with one another which is non-zero at each point. In the example shown, the valleys 6 have in plan view a tulip-shaped (or bell-shaped) contour but this shape is non-limiting and the edges of the valleys 6 could be straight, said valleys 6 then having a V-shaped contour.

Particularly advantageously, said end face 13 of each foot 4 comprises at least two sections 13a, 13b, a first so-called central section 13a extending from the central region 7 of the bottom in the direction of the top 16 of the foot 4 and having an outwardly facing concavity, and a second so-called peripheral section 13b extending from the central section 13a to the bottom of the foot 4 and having an outwardly facing convexity.

Such a construction of the foot and more particularly such a specific construction in the form of a curve connecting the feet towards the center advantageously enables the material to be displaced more easily towards the base and thus a more gradual transition of the material to be obtained from the center to the base region during the stretch blow molding production step.

Preferably, the radius of curvature of the second peripheral section 13b is between 0.5 and 3 times the base diameter pa and the radius of curvature of the first central section 13a is preferably between 0.3 and 0.6 times said base diameter φa. In this manner, the displacement of the material is optimal during the stretch blow molding step.

In this particular exemplary embodiment, the radius of curvature of the peripheral section 13b and the radius of curvature of the central section 13a are constant and of different values; however it is obvious that the radii of curvature of the peripheral section 13b and of the central section 13a could be equal without departing from the scope of the invention.

Moreover, it is also obvious that the radius of curvature of the peripheral section 13b and/or the radius of curvature of the central section 13a could potentially not be constant over the entire length of each section 13a, 13b without departing from the scope of the invention.

In addition, the clearance of the bottom corresponding to the height between the central region 7 of the bottom 3 and the tops 16 of the feet 4, i.e. the base plane, is between 0.05 and 0.15 times the base diameter a.

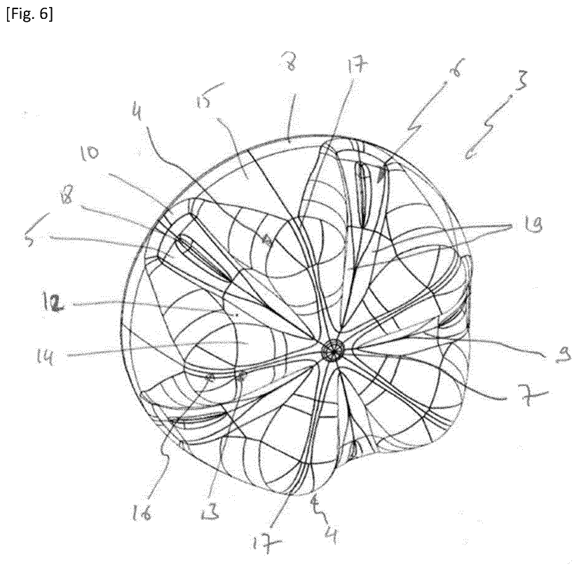

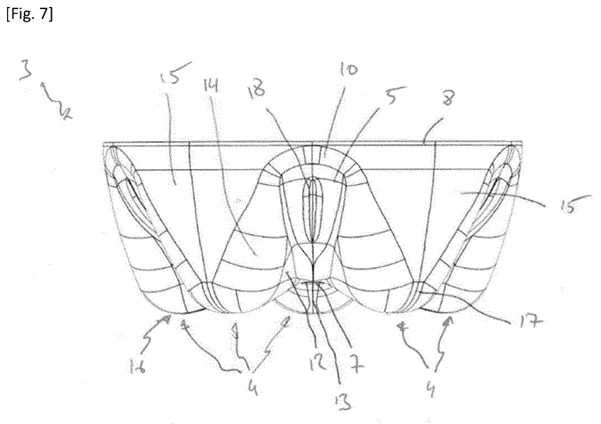

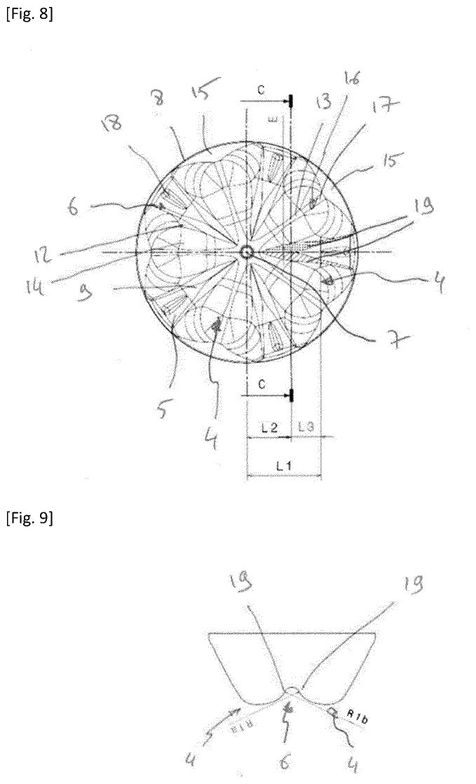

According to a variant of the bottom of the container according to the invention, with reference to FIGS. 6 to 9, said petaloid bottom 3 comprises, in the same manner as before, feet 4 formed by protrusions extending from a substantially hemispherical wall 5 with an outwardly facing convexity and forming valleys 6 between two adjacent feet 4, the hemispherical wall 5 forming the bottom of said valleys 6. The upper end of each foot 4 leads to the body 2.

In the same manner as above, said petaloid bottom 3 has five protrusions forming the feet 4, which are angularly distributed equidistantly, which extend approximately parallel to the longitudinal axis of the container 1 and which are separated from one another by radiating valleys 6 having a bottom of convex curvilinear radial extent. All of the valleys 6 converge towards a so-called central region 7 of the bottom 3, said central region 7 consisting of a slightly outwardly protruding circular plate or pellet where the material remains substantially amorphous. The bottom 3 of the container 1 is connected to the body 2 of the container 1 by a so-called connecting region 8 which is substantially cylindrical in revolution.

Thus the feet 4 are separated in pairs by portions of the bottom wall 5 called valleys 6, which extend radially in a star shape from the central region formed by the central region 7 to the periphery formed by a connecting region 8. The valleys 6 are outwardly concave in cross section, i.e. in a plane perpendicular to the radial direction. The radius of curvature of the valleys 6 can be variable. More specifically, it is preferably small in the vicinity of the central region 7 and relatively larger in the vicinity of the connecting region 8.

Moreover, the valleys 6 have, in the vicinity of the central region 7, an outwardly convex internal section 9 in radial section and, in the vicinity of the connecting region 8, an outwardly concave external section 10 in radial section.

In the example illustrated in the drawings, the bottom 3 comprises five feet 4 and five valleys 6 regularly alternating and distributed in a star shape. Moreover, the most protruding parts or tops 16 of the feet 4 are coplanar and jointly form a base via which the container 1 can rest on a flat surface, said base being circular and having a so-called base diameter which will be denoted pa in the remainder of the description, and each foot 4 has an end face 13 which extends in a gentle slope from the central region 7 of the bottom 3 towards the bottom of said foot 4.

Each foot 4 has two substantially flat sides 12 which each laterally border a valley 6. Said sides 12 are not vertical (since the base 3 would then be difficult, or even impossible, to blow mold) but inclined, opening from the valley 6 to the outside. Said sides 12 are connected to the end face 13 by a fillet 14. Each foot 4 is also delimited radially by an external face 15 which extends in the extension of the body 2 to the vicinity of the top 16 of the foot 4, to which the external face 15 is connected by a fillet 17. The external face 15 is not cylindrical but substantially conical in revolution about the longitudinal axis of the container 1. Moreover, in radial section this face 15 is not straight but convex with a large radius of curvature. On the periphery of the bottom 3, the face 15 is connected to the body 2 via the connecting region 8 which is in the form of a fillet.

Advantageously, the bottom 3 is also provided with radial grooves 18 which extend in a hollow manner to the inside of the container 1, at the bottom 3 and along the valleys 6.

More specifically, each radial groove 18 extends along a median line of a valley 6, from the vicinity of the central region 7 to the vicinity of the connecting region 8. Each groove 18 has in plan view a substantially oblong shape, the edges thereof being parallel over the majority of the length and the ends thereof being both flared. In radial section, each groove 18 has a flared U-shape profile. Said grooves 18 have the function of stiffening the bottom 3. Under the effect of the mechanical stresses exerted on the container 1 (in particular under the effect of the pressure prevailing in the container filled with a carbonated liquid) the grooves 18 tend to creep by expanding and flattening which causes an enlargement of the valleys 6 and, as a result, a verticalization of the feet 4 which opposes the general sagging of the bottom 3.

Moreover, each valley 6 is enlarged from the central region 7 to the connecting region 8. This enlargement is preferably continuous, i.e. the edges of the valleys 6 form an angle with one another which is non-zero at each point. In the example shown, the valleys 6 have in plan view a tulip-shaped (or bell-shaped) contour but this shape is non-limiting, and the edges of the valleys 6 could be straight, said valleys 6 then having a V-shaped contour.

Particularly advantageously, said end face 13 of each foot 4 comprises at least two sections 13a, 13b, a first so-called central section 13a extending from the central region 7 of the bottom in the direction of the top 16 of the foot 4 and having an outwardly facing concavity, and a second so-called peripheral section 13b extending from the central section 13a to the bottom of the foot 4 and having an outwardly facing convexity.

Preferably, the radius of curvature of the second peripheral section 13b is between 0.5 and 3 times the base diameter pa and the radius of curvature of the first central section 13a is preferably between 0.3 and 0.6 times said base diameter φa. In this manner, the displacement of the material is optimal during the stretch blow molding step.

In this particular embodiment, the radius of curvature of the peripheral section 13b and the radius of curvature of the central section 13a are substantially constant and of different values; however it is obvious that the radii of curvature of the peripheral section 13b and of the central section 13a could be equal without departing from the scope of the invention.

Moreover, it is also obvious that the radius of curvature of the peripheral section 13b and/or the radius of curvature of the central section 13a could potentially not be constant over the entire length of each section 13a, 13b without departing from the scope of the invention.

In addition, the clearance of the bottom corresponding to the

height between the central region 7 of the bottom 3 and the tops 16 of the feet 4, i.e. the base plane, is between 0.05 and 0.15 times the base diameter pa.

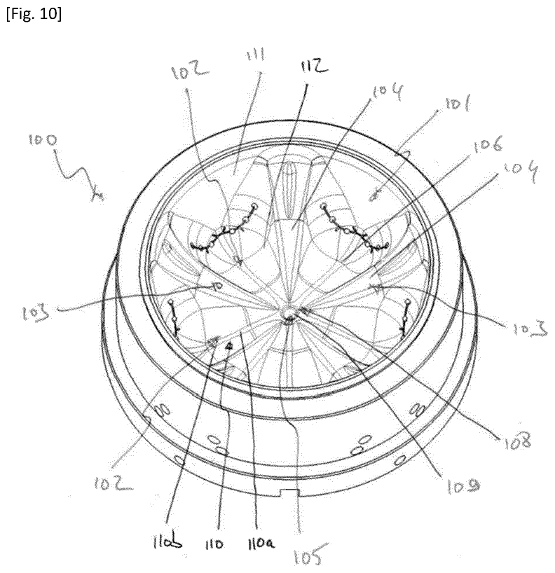

This variant is distinguished from that described above by the fact that said sides 12 of the feet 4 are connected to the valley 6 by the concave fillets 19, the radius of curvature thereof, denoted R1a and R1b in FIG. 9, not being constant from the central region 7 to the connecting region 8 of each valley 6. More specifically, said radius of curvature of the concave fillets 19 is variable over a length L₁ of the valley 6 from the central region 7 and is substantially constant from said length L₁ to the connecting region 8. Said length L₁ is between 0.2 and 0.8 times the base diameter φa, and is preferably equal to 0.5 times said base diameter φa. Moreover, said length Li can be broken down into two lengths L₂ and L₃, i.e. L₁=L₂+L₃. Said length L₂ corresponds to the length of which the starting point is the central region 7 in which the space E between the concave fillets 19 of two adjacent feet 4 separated by a valley 6 is minimal. Preferably, over this length L₂ the space E between said concave fillets 19 of two adjacent feet 4 separated by a valley 6 is less than or equal to 2 mm. It will be noted that said space E can be zero, i.e. equal to 0. In this case, the concave fillets 19 of two adjacent feet 4 are connected at a distance L₂ from the central region 7. Said

length L₂ from the central region 7 is between 0.1 and 0.4 times the base diameter pa and is preferably equal to 0.3 times said base diameter φa. Over said length L₃, the so-called transition length, the radius of curvature of the concave fillets 19 gradually reduces until it reaches the value of the constant radius of curvature of the concave fillets 19 defined for the region extending between the end of the length L₁ to the connecting region 8.

It will be noted that such a construction of the foot, and more particularly such a specific construction of the concave fillets 19 connecting the sides 12 of two adjacent feet to a valley 6, advantageously enables the material to be displaced more easily towards the base and thus a more gradual transition of the material to be obtained in the region of the valley 6 from the center to the base region during the stretch blow molding production step.

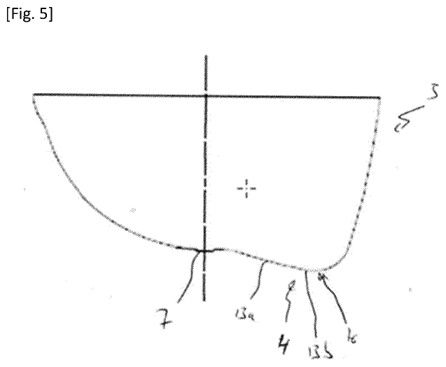

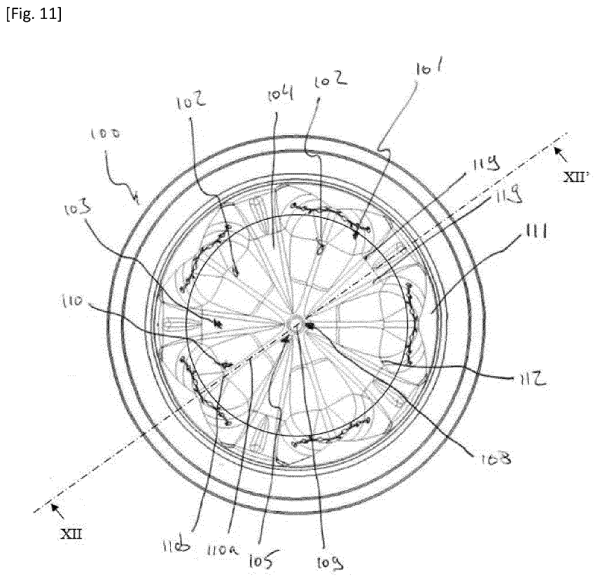

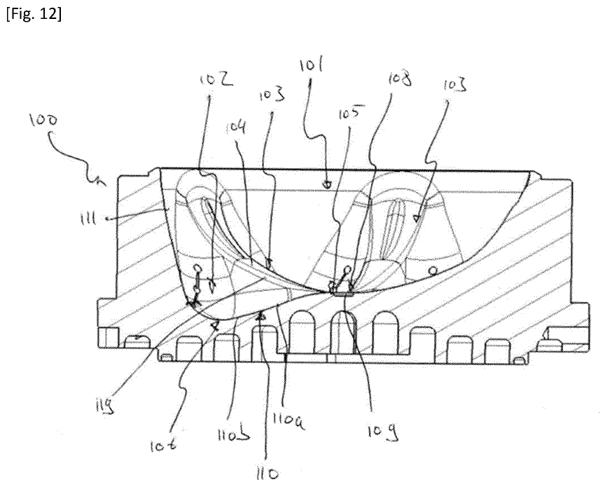

With reference now to FIGS. 10 to 12, a mold bottom 100 is shown therein, designed to equip a mold for producing, by blow molding or stretch blow molding, containers 1, in particular bottles, made of thermoplastic material, and more particularly made of rPET and/or PET, according to the invention, as described above with reference to FIGS. 1 to 5.

Said mold bottom 100 is provided with a mold cavity 101 which comprises, for the molding of said bottom 3 of the containers 1, a plurality of cavities 102 which are equal in number to the feet 4 of the bottom 3 of the containers 1, generally between three and seven, in practice between four and six (five in the example illustrated in FIGS. 1 to 5) which are angularly distributed equidistantly (mutual angular spacing of 72° in this example), which extend approximately parallel to the axis of the mold bottom 100 (which is also the axis of the mold cavity C) and which are separated from one another by radiating ridges 103 (i.e. protruding parts extending substantially radially from the mold cavity C which lead to the formation of said valleys 6 in the base 3 of the molded container 1). Each ridge 103 has a crest 104 which is of convex curvilinear radial extent and which is circular arc-shaped starting from the edge of the central indentation 105. The bottoms 106 of the cavities 101 are distributed over a substantially circular contour 107 having a given base diameter pa which corresponds to the base diameter pa of the bottom 3 of the containers 1. The center of the mold cavity 101 comprises a protruding central region 108, a circular cavity 109 of small depth being hollowed out at the center thereof for the formation of the pellet of the aforementioned central region 7 of the bottom 3 of the container 1. According to the invention, each cavity 102 has a bottom face 110 which extends in a gentle slope from the central region 108 of the mold bottom 100 to the bottom of the cavity 102. Each cavity 102, considered radially on either side of its lowest point, is defined outwardly by a curved surface portion 111 which in radial section is substantially circular arc-shaped and inwardly by a surface portion 112 with a so-called connecting curve.

In the preferred embodiment illustrated in FIGS. 10 to 12, said bottom face 110 of each cavity 102 comprises at least two sections 110a, 110b, a first so-called central section 110a extending from the central region 108 of the mold bottom 100 in the direction of the bottom of the cavity 102 and having an inwardly facing convexity of the mold bottom 100, and a second so-called peripheral section 110b extending from the central section 110a to the bottom of the cavity 102 and having an inwardly facing concavity of the mold bottom 100.

In the same manner as for the container 1 described above, the radius of curvature of the second peripheral section 110b is preferably between 0.5 and 3 times the base diameter pa and the radius of curvature of the first central section 110a is preferably between 0.3 and 0.6 times said base diameter φa. In this manner, the displacement of the material is optimal during the stretch blow molding step.

In this particular exemplary embodiment, the radius of curvature of the peripheral section 110b and the radius of curvature of the central section 110a are constant and of different values; however it is obvious that the radii of curvature of the peripheral section 110b and the central section 110a could also be equal without departing from the scope of the invention.

Moreover, it is also obvious that the radius of curvature of the peripheral section 110b and/or the radius of curvature of the central section 110a could potentially not be constant over the entire length of each section 110a, 110b without departing from the scope of the invention.

In addition, the clearance of the bottom corresponding to the height between the central region 108 of the mold bottom 100 and the bottom of the cavities 102 is between 0.05 and 0.15 times the base diameter φa.

According to one variant according to the invention, not shown in the figures, said mold bottom 100 comprises, on either side of the crest 104, a convex fillet 119 connecting the ridges 103 extending on either side of the crest, the radius of curvature of said convex fillet not being constant from the central region 108 towards the edge of the central indentation 105.

More specifically, said radius of curvature of the convex fillets 119 is variable over a length L₁ of the crest 104 from the central region 108 and is substantially constant from said length Li to the edge of the central indentation 105. Said length L₁ is between 0.2 and 0.8 times the base diameter pa and is preferably equal to 0.5 times said base diameter pa. Moreover, said length Li can be broken down into two lengths L₂ and L₃, i.e. L₁=L₂+L₃. Said length La corresponds to the length of which the starting point is the central region 108 in which the space E between the convex fillets 119 of the same crest 104 is minimal. Preferably, over this length La the space E between said convex fillets 119 of the same crest 104 is less than or equal to 2 mm. It will be noted that said space E can be zero, i.e. equal to 0. In this case, the convex fillets 119 are connected at a distance L₂ from the central region 108. Said length L₂ from the central region 108 is between 0.1 and 0.4 times the base diameter pa and is preferably equal to 0.3 times said base diameter φa. Over said length L₃, the so-called transition length, the radius of curvature of the convex fillets 119 gradually reduces until it reaches the value of the constant radius of curvature of the convex fillets 119 defined for the region extending between the end of the length L₁ to the edge of the central indentation 105.

A final subject of the invention, not shown in the figures, relates to a molding device for producing, by blow molding or stretch blow molding, containers as described above.

Said molding device comprises, in the usual manner, at least one mold bottom which is capable of being movably mounted in a lateral wall which defines a cavity with the impression of a part of the container, said lateral wall comprising two half-molds each defining a half-impression of the body of the container and rotatably mounted relative to one another between a so-called open position in which the half-molds are angularly separated from one another and the mold bottom is lowered relative to the half-molds to permit the introduction of the preform and the removal of the molded container, and a so-called closed position in which the half-molds are applied against one another and capture between one another the mold bottom, thus to form the cavity and to define the total footprint of the container to be molded, said mold bottom comprising at least three cavities which are angularly distributed equidistantly, which extend substantially parallel to the axis of the mold bottom and which are separated from one another by radiating ridges having a crest of concave radial extent, the bottoms of said cavities being distributed over a substantially circular contour. Said molding device is distinguished by the fact that said mold bottom is arranged as described above with reference to FIGS. 6 to 8.

Finally it is obvious that the examples which have been provided are only specific illustrations and are in no way limiting relative to the fields of application of the invention.

1. A container obtained by blow molding or by stretch blow molding from a blank made of plastic material, the container comprising:
a body comprising a substantially cylindrical wall, a shoulder in an extension of said body at an upper end thereof, a neck in the extension, and a bottom of the petaloid type at a lower end of said body, said bottom comprising a wall of generally outwardly convex shape, from which at least three feet formed by protrusions protruding towards the outside of the container extend, these feet extending from a pellet-shaped central region of the bottom, where the plastic material has remained substantially amorphous, towards a periphery of the bottom where the latter connects to the body, the most protruding parts or tops of the feet are coplanar and jointly form a base via which the container is configured to rest on a flat surface, said base being circular and having a base diameter ωa, and each foot having an end face which extends in a gentle slope from the central region of the bottom towards the bottom of said foot, Wherein said end face of each foot comprises at least two sections, a first central section extending from the central region of the bottom in the direction of the top of the foot and having an outwardly facing concavity, and a second peripheral section extending from the central section to the bottom of the foot and having an outwardly facing convexity.

2. The container as claimed in claim 1, wherein a radius of curvature of the second peripheral section is between 0.5 and 3 times the base diameter φa.

3. The container as claimed in claim 1, wherein A radius of curvature of the central section is between 0.3 and 0.6 times the base diameter φa.

4. The container as claimed in claim 1, wherein one or both of a radius of curvature of the peripheral section and a radius of curvature of the central section is not constant.

5. (canceled)

6. The container as claimed in claim 1, wherein a clearance of the bottom corresponding to a height between the central region of the bottom and the tops of the feet is between 0.05 and 0.15 times a base diameter φa.

7. The container as claimed in claim 1, wherein each foot has two substantially flat sides which each laterally border a valley, said sides of the feet being connected to the valley via concave fillets, a radius of curvature thereof not being constant from the central region to a connecting region of each valley.

8. The container as claimed in claim 7, wherein said radius of curvature of the concave fillets is variable over a length L₁ of the valley from the central region and is substantially constant from said length L₁ to the connecting region.

9. The container as claimed in claim 8, wherein said length L₁ is between 0.2 and 0.8 times the base diameter φa.

10. The container as claimed in claim 8, wherein over a part L₂ of the length L₁, said concave fillets are separated by a space E which is less than or equal to 2 mm, a starting point of the length L₂ being the central region.

11. (canceled)

12. The container as claimed in claim 10, wherein said length L₂ from the central region is between 0.1 and 0.4 times the base diameter φa.

13. The container as claimed in claim 10, wherein over a remaining transition length L₃, the radius of curvature of the concave fillets gradually reduces until the radius reaches a value of the defined for the region extending between an end of the length L₁ to the connecting region.

14. A mold bottom for a mold for producing, by blow molding or stretch blow molding, containers, made of thermoplastic material PET:
said containers comprising a body of a substantially cylindrical wall, a shoulder in the extension of said body at an upper end thereof, a neck in the extension of the shoulder, and a bottom of the petaloid type at a lower end of said body, said bottom comprising a wall of generally outwardly convex shape, from which extends at least three feet formed by protrusions which are angularly distributed equidistantly, which feet extend approximately parallel to the axis of the container and which are separated from one another by radiating valleys having a bottom of convex curvilinear radial extent;
said mold bottom comprising, for the molding of said bottom of the containers, at least three cavities which are angularly distributed equidistantly, which cavities extend substantially parallel to an axis of the mold bottom and which are separated from one another by radiating ridges having a crest of concave radial extent, wherein bottoms of said cavities are distributed over a substantially circular contour corresponding to a base diameter pa of the container, and each cavity having a bottom face which extends in a gentle slope from a central region of the bottom towards the bottom of the cavity; wherein a bottom face of each cavity comprises at least two sections, a first central section extending from the central region of the mold bottom in the direction of the bottom of the cavity and having an inwardly facing convexity of the mold bottom, and a second peripheral section extending from the central section to the bottom of the cavity and having an inwardly facing concavity of the mold bottom.

15. The mold bottom as claimed in claim 14, wherein a radius of curvature of the second peripheral section is between 0.5 and 3 times the base diameter φa.

16. The mold bottom as claimed in claim 14, wherein a radius of curvature of the central section is between 0.3 and 0.6 times the base diameter φa.

17. The mold bottom as claimed in claim 14, wherein one or both of a radius of curvature of the peripheral section and a radius of curvature of the central section is not constant.

18. (canceled)

19. The mold bottom as claimed in 14, wherein a clearance of the bottom corresponding to a height between the central region of the mold bottom and the bottom of the cavities is between 0.05 and 0.15 times the base diameter φa.

20. The mold bottom as claimed in claim 14, comprising, on either side of the crest, a convex fillet connecting the ridges extending on either side of the crest, the radius of curvature of said convex fillet not being constant from the central region towards the edge of the central indentation, wherein said radius of curvature of the convex fillets is variable over a length L₁ of the crest from the central region and is substantially constant from said length L₁ to the edge of the central indentation.

22-26. (canceled)

27. A molding device for producing containers, by blow molding or stretch blow molding, from preforms made of thermoplastic material, said containers comprising:
a body consisting of a substantially cylindrical wall, a shoulder in the extension of said body at an upper end thereof, a neck in an extension of the shoulder, and a petaloid bottom at the lower end of said body, said bottom comprising a wall of generally outwardly convex shape, from which extend at least three feet formed by protrusions which are angularly distributed equidistantly, which extend approximately parallel to the axis of the container and which are separated from one another by radiating valleys having a bottom of convex curvilinear radial extent; and said molding device comprising:
at least one mold bottom configured to be movably mounted in a lateral wall which defines a cavity with an impression of a part of the container, said lateral wall comprising two half-molds each defining a half-impression of the body of the container and rotatably mounted relative to one another between an open position in which the half-molds are angularly separated from one another and the mold bottom is lowered relative to the half-molds in order to permit the introduction of the preform and the removal of the molded container, and a closed position in which the half-molds are applied against one another and capture between one another the mold bottom, thus to form the cavity and to define the total footprint of the container to be molded, said mold bottom comprising at least three cavities which are angularly distributed equidistantly, which cavities extend substantially parallel to an axis of the mold bottom and which are separated from one another by radiating ridges having a crest of concave radial extent, wherein bottoms of said cavities are distributed over a substantially circular contour.
